(19) United States
(12) Patent Application Publication
(10) Pub. No.: US 2018/0082247 A1
(43) Pub. Date: Mar. 22, 2018

(54) ELECTROMAGNETIC PERMEABILITY THROUGH MODULAR BACKSPLASH

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/711,183

(22) Filed: Sep. 21, 2017

Related U.S. Application Data
(60) Provisional application No. 62/397,468, filed on Sep. 21, 2016.

(51) Int. Cl. G06Q 10/08; G06Q 30/02

(52) U.S. Cl. CPC G06Q 10/087; G06Q 30/0205

(57) ABSTRACT

Apparatuses, systems, and methods are provided herein useful to determining qualities associated with products presented for sale. In some embodiments, the system includes a transmitter located on a first side of a group of products, the transmitter configured to emit energy toward the group of products, and a receiver located on the first side, wherein the receiver is configured to receive a first portion of the energy and a second portion of the energy, wherein the first portion of the energy is reflected off of the group of products, wherein the second portion of the energy is reflected off of a surface located on a second side of the group of products, wherein the first portion of the energy and/or the second portion of the energy is used to estimate a quantity of items in the group of products and/or a type of items in the group of products.

### CROSS-REFERENCE TO RELATED APPLICATION

This application claims the benefit of U.S. Provisional Application No. 62/397,468, filed Sep. 21, 2016, which is incorporated herein by reference in its entirety.

### TECHNICAL FIELD

This invention relates generally to products presented for sale in a shopping facility and, more particularly, to determining qualities of the products presented for sale in a shopping facility.

### BACKGROUND

Guests of a shopping facility may become frustrated when they are unable to locate products that they would like to purchase. Oftentimes, guests cannot find the products they would like to purchase because products are not properly stocked (e.g., the product display unit on which the product should be located is empty) or incorrectly located within the shopping facility (e.g., the product on a product display unit is not the correct product). Guest satisfaction is improved when products presented for sale in the shopping facility are properly stocked and located. Additionally, the number of products that each guest purchases may increase when products are properly stocked and located. Consequently, there exists a need for systems and methods that ensure that products presented for sale in a shopping facility are properly stocked and located.

### BRIEF DESCRIPTION OF THE DRAWINGS

Disclosed herein are embodiments of systems, apparatuses and methods useful for determining qualities of products presented for sale in a shopping facility. This description includes drawings, wherein:

FIG. 1 depicts a product display unit 100 including transmitters 104 and first reflective surfaces 102, according to some embodiments;

FIG. 2 is a side view of a shelf 220 of a product display unit 202 including a transmitter 218, according to some embodiments; and

FIG. 3 is a flow chart depicting example operations for estimating a stock level and/or a type of product presented for sale on a product display unit, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to determining qualities associated with products presented for sale in a shopping facility. In some embodiments, the system includes a transmitter located on a first side of a group of products, wherein the transmitter is configured to emit energy toward the group of products, wherein the group of products is located on a product display. The system can also include a receiver located on the first side of the group of products, wherein the receiver is configured to receive a first portion of the energy and a second portion of the energy, wherein the first portion of the energy is reflected off of the group of products, wherein the second portion of the energy is reflected off of a surface located on a second side of the group of products, wherein at least one of the first portion of the energy and the second portion of the energy is used to estimate one or more of a quantity of items in the group of products and a type of items in the group of products.

Shopping facilities strive to maintain proper stocking and placement of products presented for sale on product display units within the shopping facility. Ensuring that all products presented for sale in the shopping facility are properly stocked and located is a labor-intensive and time-consuming task. Additionally, this task must be performed repeatedly to ensure that the products presented for sale remain properly stocked and located. Embodiments of the inventive subject matter include systems, apparatuses, and methods that aid a shopping facility in ensuring that products are properly stocked, and properly located, on product display units within the shopping facility. Some embodiments of the inventive subject matter include transmitters and receivers. The transmitters emit energy toward, and in some cases through, products presented for sale on a product display. The receivers receive the energy emitted by the transmitters. The transmitters and the receivers are located on the same side of the products. Properties associated with the energy (e.g., energy, dispersion, arrival angle, phase, etc.) change as the energy is reflected off of the products, travels through the products, and is reflected off of a surface located on an opposite side of the products. A number of products and/or a type of products located on the product display can be estimated based on the received energy.

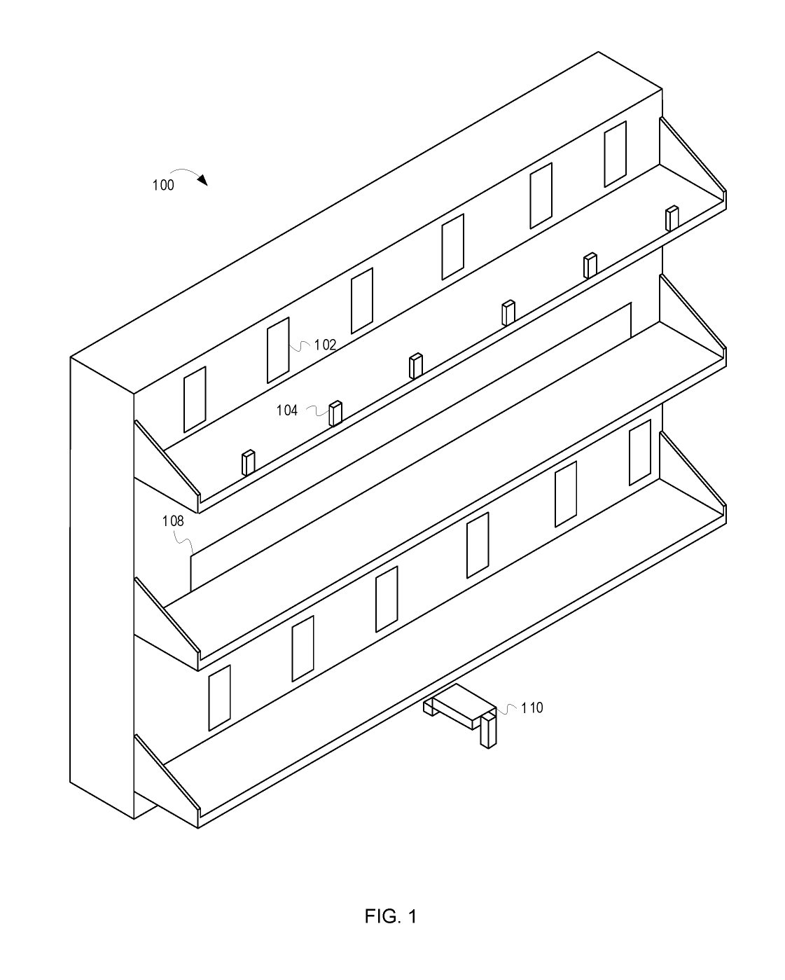

FIG. 1 depicts a product display unit 100 including transmitters 104, according to some embodiments. The transmitters 104 are affixed to the product display unit 100. In some embodiments, each row of products on the product display unit 100 has an associated transmitter (i.e., the transmitters 104). The product display unit 100 can include a reflective portion configured to reflect energy emitted by the transmitters 104. For example, as depicted in FIG. 1, each row of products on the product display unit 100 can have an associated reflective portion (i.e., first reflective portions 102). In other embodiments, a section of the product display unit (e.g., a shelf, a portion of a shelf, etc.) has a single reflective portion (e.g., second reflective portion 108). The reflective portions can be affixed to the product display unit 100 or embedded in the product display unit 100. For example, the reflective portion can be a metallic piece affixed to, or embedded in, the product display unit 100, or pieces of material (e.g., metallic fleck) affixed to or embedded in the product display unit 100. Further, in some embodiments, the product display unit 100 can itself be reflective (e.g., made of a reflective material).

The transmitters 104 emit energy (e.g., radiofrequency (RF) waves) and receivers receive the emitted energy. The energy can be reflected off of products on the product display unit 100 and/or the product display unit (e.g., off of the first reflective portions 102). In one embodiment, the receivers are positioned near the transmitters 104 (e.g., in a housing shared with the transmitters 104). Alternatively, the transmitters 104 can also act as receivers (i.e., transceivers). In such embodiments, the transmitters 104 can receive the reflected energy. In addition to, or in lieu of, the transmitters 104 that are affixed to the product display unit 100, embodiments of the inventive subject matter include portable transmitters 110 (e.g., a portable transmitter 110 located on a mobile device). The portable transmitter 110 can be operated by a person (e.g., handheld, attached to a movable device, etc.) or automated. In an automated system, the portable transmitter 110 can be affixed to a robotic device. The robotic device can travel through the shopping facility on a predetermined path. For example, using a coordinate system or location determination, the robotic device can follow the predetermined path. The portable transmitter 110 can be configured to rest on or near a shelf at a predetermined distance. Such a design is beneficial because the portion of the energy emitted is dependent on the distance between the portable transmitter 110 and the products and/or the receiver. The portable transmitter 110 can include receivers (i.e., dedicated receivers or transceivers). Based on the reflected energy (i.e., energy reflected from the products and/or the product display unit 100), the system can estimate a number of products and/or a type of products located on the product display unit 100.

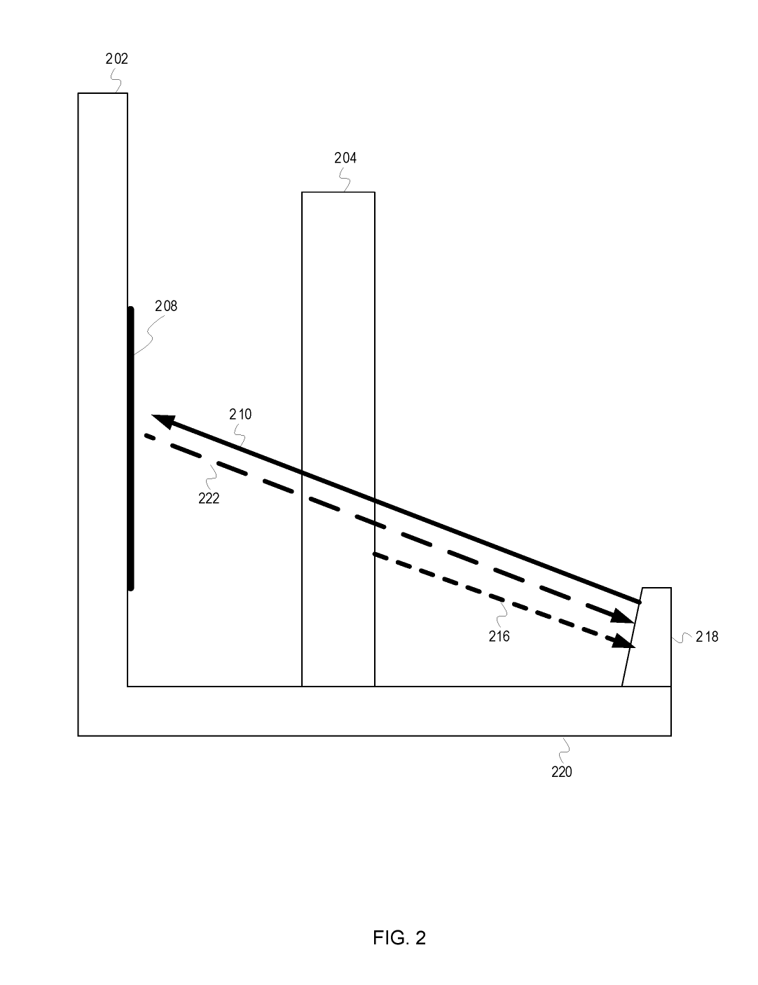

While FIG. 1 provides an overview of an example system for using energy transmission to estimate stock levels in a shopping facility, FIG. 2 and the associated text provide greater details of the system.

FIG. 2 is a side view of a shelf 220 of a product display unit 202 including a transmitter 218, according to some embodiments. The transmitter 218 emits energy toward and through a product 204 presented for sale on the shelf 220, as indicated by transmission arrow 210. The emitted energy is received by a receiver, as indicated by a first reflective arrow 222 and a second reflective arrow 216. A portion of the energy passes through the product 204 and is reflected off of a reflective portion 208 of the product display unit 202, as indicated by the first reflective arrow 222. A second portion of the energy is reflected off of the product 204, as indicated by the second reflective arrow 216. The receiver can be positioned near the transmitter 218 (e.g., included in the same housing as the transmitter 218) or the transmitter 218 can include the receiver (i.e., the transmitter 218 is a transceiver). Properties of the reflected energy (e.g., a magnitude, wavelength, reflection delay, etc.) are indicative of properties associated with the product 204.

In some embodiments, interference with the energy transmitted toward and through the product 204 can be calculated by comparison to the Friis transmission equation (i.e., Pᵣ/Pₜ=GₜG_{τ}(Λ/4πR)²). Because the Friis transmission equation can be used to calculate the degradation in energy during transmission from the transmitter 218 to the receiver when nothing is present to interfere, deviations in the received energy are indicative of the product 204. As one example, if the transmitter 218 is transmitting at a frequency of 902-928 MHz, the power is 1000 mW, with a wavelength of 13.1 inches, the power degradation at a distance of 12 inches would be approximately 7.5 mW. Therefore, any degradation in power greater than 7.5 mW would be indicative of the product 204.

In some embodiments the system can determine a number of the product 204 that are on the shelf 220 based on these properties. For example, the delay between the emission of the energy and the reception of the reflected portion of the energy is indicative of how far the product 204 is from the transmitter 218 and/or receiver. If the distance indicates that the product 204 is at the rear of the shelf 220, it may indicate that the product is not properly zoned on the shelf or that an insufficient number of the product 204 is on the shelf 220. Further, the arrival angle of the reflected energy may be indicative of the number of the product 204 on the shelf 220. For example, the arrival angle of the energy reflected off of the product 204 may be different dependent upon the distance that the product 204 is away from the transmitter 218 and/or the receiver. The distance that the product 204 is away from the transmitter 218 and/or the receiver may be indicative of the number of the product 204 on the shelf 220.

In some embodiments, the system can determine a type of the product 204 based on the properties of the energy reflected off of the product 204. The system can determine the type of the product 204 because different products have different reflectivity properties. For example, metallic packaging, such as soup cans, may reflect more energy than nonmetallic packaging. Additionally, different types of nonmetallic packaging may have different reflectivity properties (e.g., clothes versus cardboard boxes), or the reflectivity of a product may vary based on the product inside the packaging (e.g., a cardboard box containing pasta compared to a cardboard box containing a plastic object). Determining a type of product based on the reflected energy can be useful in determining that products are incorrectly located on the product display unit 202. For example, if the product 204 exhibits high reflectivity properties but the product display unit 202 is supposed to present boxes of cereal for sale, the product 204 may be the wrong product (i.e., a product other than a box of cereal).

In some embodiments, the system can determine a type of the product 204 based on energy that is reflected off of the reflective portion 208. The system can determine the type of the product 204 because different products have different absorptivity properties. For example, products that contain more water (e.g., a bottled beverage) may absorb more energy than a cardboard box containing an item of low density. Determining a type of product based on the reflected energy can be useful in determining that products are incorrectly located on the product display unit 202. For example, if the product 204 has low absorptivity properties but the product display unit 202 is supposed to present bottled water for sale, the product 202 may be the wrong product (i.e., a product other than bottled water). Additionally, the system may be able to determine the number of the product 204 on the shelf 220 based on the energy that is reflected from the reflective portion 208. For example, if the shelf 220 is supposed to have five bottles of water in a row but the energy reflected by the reflective portion 208 indicates that only a small portion was absorbed, it may indicate that fewer than five water bottles are located on the shelf 220.

In further embodiments, the system can use indications of the energy reflected by the product 204 and the energy reflected by the reflective portion 208 to estimate the number of the product 204 and/or the type of the product 204. Using both the indication of the energy reflected by the product 204 and the energy reflected by the reflective portion 208 may allow the system to more accurately estimate the number of the product 204 and/or the type of the product 204 on the shelf 220. For example, if the most accurate method of estimating the number of the product 204 on the shelf is based on an angle of arrival of the reflected energy, the indication of the energy reflected by the product 204 may be a better indicator of the number of the product 204 on the shelf 220 than the indication of the energy reflected by the reflective portion. Further, if the most accurate method of estimating the type of the product 204 on the shelf is based on the absorptivity properties of the product 204 on the shelf 220, the indication of the energy reflected by the reflective portion 208 may be a better indicator of the type of the product 204 on the shelf 220 than the indication of the energy reflected by the product 204. In such a scenario, the system may be able to estimate most accurately the number of the product 204 and the type of the product 204 based on indications of both of the reflected energies. If the system is utilizing both of the reflected energies, the system can determine between the two based on arrival angle, energy level, wave phase, etc. For example, the system can compare any of these value associated with each of the reflected energies to distinguish the portion of the energy reflected by the product from the portion of the energy reflected by the product display unit (e.g., a reflective portion of the product display unit).

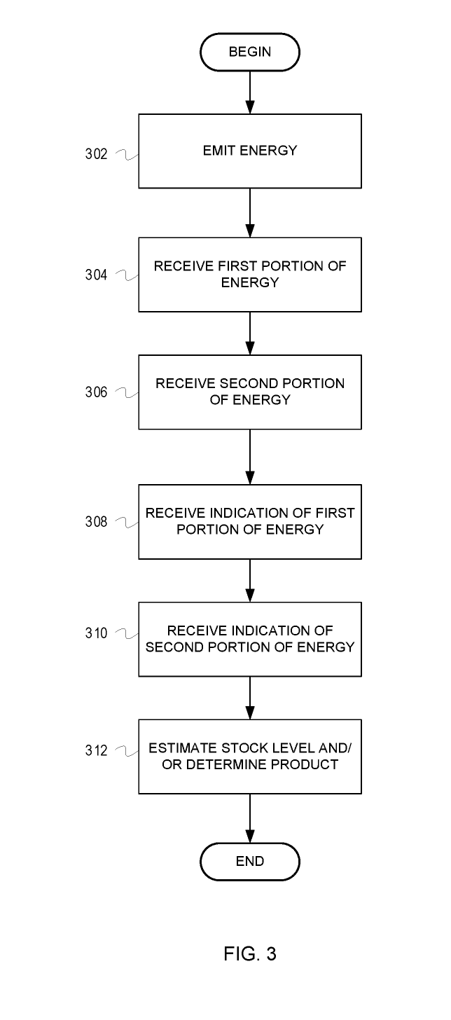

While FIG. 2 and the related text describe a system for estimating the number of products and/or the type of products located on a product display unit, FIG. 3 is a flow chart including example operations for estimating the number of products and/or the type of products located on a product display unit.

FIG. 3 is a flow chart depicting example operations for estimating a number, or type, of product presented for sale on a product display unit, according to some embodiments. The flow begins at block 302.

At block 302, energy is emitted toward and through a group of products. For example, a transmitter emits the energy toward and through the group of products. The transmitter can be located (whether permanent or movable) at a first side of the group of products. The energy (e.g., electromagnetic waves) can be emitted in any suitable wavelength. In some embodiments, the magnitude of the energy and the wavelength of the energy are based on the products toward and through which the energy is intended to be emitted. Additionally, the magnitude and wavelength of the emitted energy can be varied based on environmental conditions. For example, the magnitude and wavelength of the emitted energy can be varied based on temperature, humidity, atmospheric pressure, elevation, etc., as the conditions may affect the transmission and/or absorption of the energy. The flow continues at block 304.

At block 304, a first portion of the emitted energy is received. For example, a receiver can receive the transmitted portion of the emitted energy. The first portion of the emitted energy can be reflected off of the products in the group of products and the receiver can be located at the first side of the group of products. Further, the receiver can be a dedicated receiver located in a location suitable for detecting the first portion of the energy or can be combined with the transmitter. Because the energy is reflected by the group of products, the group of products may absorb and/or disperse some of the emitted energy. The energy received by the receiver is the portion of the energy that was neither absorbed nor dispersed by the group of products. In some embodiments, the first portion of the energy can be used to estimate either the number of products in the group of products, the type of products in the group of products, or both. The flow continues at block 306.

At block 306, a second portion of the emitted energy is received. For example, the receiver can receive the second portion of the emitted energy. Because the energy is transmitted through the group of products, the group of products may absorb and/or reflect some of the emitted energy. The second portion of the emitted energy is the portion of the energy that was neither absorbed nor reflected by the group of products. In some embodiments, the second portion of the energy can be used to estimate either the number of products in the group of products, the type of products in the group of products, or both. The flow continues at block 308.

At block 308, an indication of the first portion of the energy is received. For example, a control circuit can receive the indication of the first portion of the energy. The indication of the first portion of the energy can indicate the magnitude of the first portion of the energy, as well as other properties associated with the first portion of the energy (e.g., an arrival angle, a wavelength, an amplitude, etc.) or the environmental conditions. For example, the indication of the first portion of the energy can include a current temperature, humidity, atmospheric pressure, elevation, etc. The flow continues at block 310.

At block 310, an indication of the second portion of the energy is received. For example, a control circuit can receive the indication of the second portion of the energy. The indication of the second portion of the energy can indicate the magnitude of the second portion of the energy, as well as other properties associated with the second portion of the energy (e.g., an arrival angle, a wavelength, an amplitude, etc.) or environmental conditions. For example, the indication of the second portion of the energy can include a current temperature, humidity, atmospheric pressure, elevation, etc. The flow continues at block 312.

At block 312, a stock level is estimated and/or a type of product is estimated. For example, the control circuit estimates the stock level and/or estimates the type of product. The control circuit can estimate the stock level based on the indication of the first portion of the energy and/or the indication of the second portion of the energy. Additionally, the control circuit can estimate the type of product based on the indication of the first portion of the energy and/or the indication of the second portion of the energy. In some embodiments, using both the indication of the first portion of the energy and the indication of the second portion of the energy to estimate the stock level and/or determine the type of product is more accurate than using only the indication of the first portion of the energy or the indication of the second portion of the energy. Because the energy is absorbed and/or reflected by the group of products, the portion of the energy transmitted relative to the second portion of the energy is indicative of the stock level (i.e., the number of products in the group of products) as well as the type of the product in the group of products. For example, the greater the number of products in the group of products, the lesser the second portion of the energy (i.e., the greater the amount of the energy emitted that is absorbed and/or reflected by the group of products). In some embodiments, the stock level and/or type of the product is estimated based on a predetermined energy level (e.g., based on experimental or observed data). For example, a relationship between type of product, location of product on the product display unit, and number of products on the product display unit and portion of the energy transmitted can be determined. As a baseline value, the transmitter can emit the energy when no products are located on the product display unit. This can be repeated for one or more other conditions (e.g., with differing numbers of products on the product display unit) to obtain a greater number of data points. In some embodiments, the variation between the energy received can range from zero (i.e., total absorption by the product) to an energy up to ten times greater than an empty product display unit. As previously discussed, the power will degrade as it travels through air. If a metallic product (e.g., metal cans or packaging) is on the product display unit, the energy will not make it to the rear of the product display unit for reflection. Instead all, or a large portion, of the energy transmitted will be reflected by the metallic product. Because the energy does not travel as far, the energy received by the receiver will be greater than if the product display unit is empty (i.e., if the energy were absorbed as it travelled the full distance to the rear of the product display unit and back to the receiver). At the other end of the spectrum, a product may absorb all of the energy such that no, or a very small amount, of energy is received by the receiver. For example, water absorbs a significant portion of emitted energy. If the product display unit contains bottles of water, the energy will be absorbed as it passes through the water bottles, and absorbed further when the energy is reflected off of the back of the product display unit. At a 1000 mW power, all of the energy may be absorbed by passing through twenty-four inches of water bottles. Consequently, if the quantity of water bottles requires the energy to pass through twelve inches of water bottles, the received energy will be zero, or close to zero. For products that are not completely metallic or not completely absorptive (e.g., fabric), the amount of energy received will be somewhere between these two values (i.e., roughly ten times the baseline value and zero). In some instances, the products may absorb ambient moisture, increasing the absorptivity of the products. The relationship between the products on the product display unit and the second portion of the energy can be determined based on these data points (e.g., by plotting a curve). Additionally, a similar process can be used to determine a relationship between environmental conditions and the second portion of the energy (e.g., the amount of ambient moisture absorbed by the products). Additionally, when estimating the stock level, the control circuit can account for the current temperature, humidity, atmospheric pressure, elevation, time, etc.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, although this specification refers to determine stock level and product type for products presented for sale in a shopping facility, embodiments are not so limited. Some embodiments of the inventive subject matter can be used in environments other than a sales floor of a shopping facility. For example, embodiments of the inventive subject matter can be used in a stock room, a shipping facility, a warehouse, or any other locations where determining a number of items or type of items can be useful.

In some embodiments, the system includes a transmitter located on a first side of a group of products, wherein the transmitter is configured to emit energy toward the group of products, wherein the group of products is located on a product display. The system can also include a receiver located on the first side of the group of products, wherein the receiver is configured to receive a first portion of the energy and a second portion of the energy, wherein the first portion of the energy is reflected off of the group of products, wherein the second portion of the energy is reflected off of a surface located on a second side of the group of products, wherein at least one of the first portion of the energy and the second portion of the energy is used to estimate one or more of a quantity of items in the group of products and a type of items in the group of products.

In some embodiments, a method comprises emitting, via a transmitter on a first side of a group of products, energy toward the of products, wherein the group of products is located on a product display, and receiving, via a receiver on the first side of the group of products, a first portion of the energy and a second portion of the energy, wherein the first portion of the energy is reflected off of the group of products, wherein the second portion of the energy is reflected off of a surface located on a second side of the group of products, wherein at least one of the first portion of the energy and the second portion of the energy is used to estimate one or more of a quantity of items in the group of products and a type of items in the group of products.

What is claimed is:

1. A system comprising:
a transmitter located on a first side of a group of products, wherein the transmitter is configured to emit energy toward the group of products, wherein the group of products is located on a product display; and
a receiver located on the first side of the group of products, wherein the receiver is configured to receive a first portion of the energy and a second portion of the energy, wherein the first portion of the energy is reflected off of the group of products, wherein the second portion of the energy passes through the group of products and is reflected off of a surface located on a second side of the group of products, wherein at least one of the first portion of the energy and the second portion of the energy is used to estimate one or more of a quantity of items in the group of products and a type of items in the group of products.

2. The system of claim 1, further comprising:
a control circuit, wherein the control circuit is configured to:
receive an indication of the first portion of the energy and an indication of the second portion of the energy; and
estimate, based on at least one of the indication of the first portion of the energy and the indication of the second portion of the energy, one or more the quantity of items in the group of products and the type of items in the group of products.

3. The system of claim 2, wherein the control circuit is further configured to:
determine, based on at least one of the indication of the first portion of the energy and the indication of the second portion of the energy, that an incorrect product is located on the product display.

4. The system of claim 2, wherein the indication of the first portion of the energy includes first incidence angle information and the indication of the second portion of the energy includes second incidence angle information, and wherein control circuit is further configured to:
distinguish, based on the first incidence angle information and the second incidence angle information, between the first portion of the energy and the second portion of the energy.

5. The system of claim 2, wherein the control circuit is further configured to determine that the product display needs to be restocked.

6. The system of claim 5, wherein the control circuit is further configured to transmit an indication that the product display needs to be restocked.

7. The system of claim 2, wherein the control circuit is further configured to account for one or more of temperature, humidity, atmospheric pressure, time, and elevation to estimate one or more the quantity of items in the group of products and the type of items in the group of products.

8. The system of claim 1, wherein the surface located on a second side of the group of products is embedded with a metallic material.

9. The system of claim 1, wherein the transmitter is further configured to controllably vary characteristics of the energy.

10. The system of claim 9, wherein the characteristics of the energy include one or more of frequency and power.

11. A method comprising:
emitting, via a transmitted on a first side of a group of products, energy toward the group of products, wherein the group of products is located on a product display;
receiving, via receiver on the first side of the group of products, a first portion of the energy and a second portion of the energy, wherein the first portion of the energy is reflected off of the group of products, wherein the second portion of the energy passes through the group of products and is reflected off of a surface located on a second side of the group of products, wherein at least one of the first portion of the energy and the second portion of the energy is used to estimate one or more of a quantity of items in the group of products and a type of items in the group of products.

12. The method of claim 11, further comprising:
receiving, by a control circuit, an indication of the first portion of the energy and an indication of the second portion of the energy; and
estimating, by the control circuit based on at least one of the indication of the first portion of the energy and the indication of the second portion of the energy, one or more of the quantity of items in the group of products and the type of items in the group of products.

13. The method of claim 11, further comprising:
determining, by the control circuit based on at least one of the indication of the first portion of the energy and the indication of the second portion of the energy, that an incorrect product is located on the product display.

14. The method of claim 11, wherein the indication of the first portion of the energy includes first incidence angle information and the indication of the second portion of the energy includes second incidence angle information, and further comprising:
distinguishing, based on the first incidence angle information and the second incidence angle information, between the first portion of the energy and the second portion of the energy.

15. The method of claim 11, further comprising:
determining, by the control circuit, that the product display needs to be restocked.

16. The method of claim 15, further comprising:
transmitting an indication that the product display needs to be restocked.

17. The method of claim 11, wherein the control circuit accounts for one or more of temperature, humidity, atmospheric pressure, time, and elevation when estimating one or more the quantity of items in the group of products and the type of items in the group of products

18. The method of claim 11, wherein the surface located on a second side of the group of products is embedded with a metallic material.

19. The method of claim 11, further comprising:
varying characteristics of the energy.

20. The method of claim 19, wherein the characteristics of the energy include one or more of frequency and power.
